(19) United States
(12) Patent Application Publication
(10) Pub. No.: US 2025/0201838 A1
(43) Pub. Date: Jun. 19, 2025

(54) ANODE ACTIVE MATERIAL FOR SECONDARY BATTERY, METHOD FOR PREPARING SAME, AND SECONDARY BATTERY COMPRISING SAME

(71) Applicant: LK Technology Co., Ltd., Gyeongju-si, Gyeongsangbuk-do (KR)

(72) Inventor: Joo Suek KIM, Yongin-si (KR)

(21) Appl. No.: 18/846,612

(22) PCT Filed: Nov. 25, 2022
(86) PCT No.: PCT/KR2022/018857

§ 371 Date: Sep. 12, 2024

(30) Foreign Application Priority Data
Mar. 25, 2022 (KR) 10-2022-0037332

(51) Int. Cl. H01M 4/58; C01B 33/20

(52) U.S. Cl. CPC H01M 4/5825; C01B 33/20; C01P 2002/72; C01P 2002/82; C01P 2004/03; C01P 2004/61; C01P 2004/62; C01P 2004/64; C01P 2006/40

(57) ABSTRACT

The present invention relates to an anode active material for a secondary battery, a method for preparing same, and a secondary battery comprising same, the anode active material comprising silicon (Si)-based particles which comprise M-O—Si bonds (where M is a metal).

### TECHNICAL FIELD

Embodiments of the present disclosure relate to an anode active material for secondary batteries, a method of manufacturing the same, and a secondary battery containing the same.

### BACKGROUND ART

A silicon anode material is in the spotlight as an anode material for next-generation batteries in the field of lithium-ion secondary batteries because it has a theoretical specific capacity of more than 10 times compared to a commercially available graphite material (370 mAh/g).

However, the silicon anode material has a problem that the volume is increased by 300% or more by reaction of lithium ions with silicon during charging and thus the silicon is separated from the electrode due to large volume changes upon repeated charging and discharging.

### DISCLOSURE

### Technical Problem

Embodiments of the present disclosure provide an anode active material for secondary batteries that suppresses volume changes during repeated charging and discharging and thus exhibits excellent electrochemical characteristics.

Other embodiments of the present disclosure provide a method of manufacturing the anode active material for secondary batteries.

Yet other embodiments of the present disclosure provide a secondary battery containing the anode active material for secondary batteries.

### Technical Solution

Embodiments of the present disclosure provide an anode active material for a secondary battery including silicon (Si)-based particles, wherein the silicon (Si)-based particles include a M-O—Si bond (wherein M is a metal).

The metal (M) may include B, P, Ge, Ti, Zr, or a combination thereof.

The silicon (Si)-based particles may further include an Si—Si bond.

The silicon (Si)-based particles may be manufactured by reducing waste glass containing silica and metal oxide at a temperature of 200° C. to 350° C.

The silicon (Si)-based particles may have transmittance peaks corresponding to the M-O—Si bonds at 800 cm⁻¹ to 900 cm⁻¹ wavenumbers, 650 cm⁻¹ to 750 cm⁻¹ wavenumbers, or a combination thereof in a Fourier transform-infrared (FT-IR) spectrum.

The silicon (Si)-based particles may have an average particle diameter of 0.05 μm to 5 μm.

Embodiments of the present disclosure provide a method of manufacturing an anode active material for a secondary battery, the method including reducing waste glass containing silica and metal oxide at a temperature of 200° C. to 350° C. to produce silicon (Si)-based particles, wherein the produced silicon (Si)-based particles include a M-O—Si bond (wherein M is a metal).

The waste glass may be heat-strengthened glass produced by display disposal.

The metal of the metal oxide and the metal (M) may include B, P, Ge, Ti, Zr, or a combination thereof.

The reduction may be performed by adding a reducing agent containing Al, AlCl₃, Zn, Mg, Ca, or a combination thereof.

Embodiments of the present disclosure provide a secondary battery including an anode containing the anode active material, a cathode, and an electrolyte.

The anode may have a capacity of 800 mAh/g to 1,700 mAh/g at 1 C.

The anode may have a volume change of 5% to 40% after 50 cycles of charge and discharge at 0.5 C.

### Advantageous Effects

The anode active material for secondary batteries according to one embodiment is capable of improving the electrochemical characteristics of the secondary batteries by inhibiting volume changes generated during repeated charge and discharge, and is eco-friendly by recycling the waste glass of various displays.

### DESCRIPTION OF DRAWINGS

FIGS. 1A and 1B are scanning electron microscope (SEM) images of anode active materials for secondary batteries according to Example 1 and Comparative Example 1, respectively.

FIGS. 2A and 2B are X-ray diffraction (XRD) graphs of anode active materials for secondary batteries according to Example 1 and Comparative Example 1, respectively.

FIGS. 3A and 3B are graphs showing Fourier transform-infrared (FT-IR) spectra of anode active materials for secondary batteries according to Example 1 and Comparative Example 1, respectively.

FIGS. 4A and 4B are graphs showing changes in voltage and discharge capacity depending on the initial cycle of charge and discharge in the secondary batteries according to Example 1 and Comparative Example 1, respectively.

FIGS. 5A and 5B are graphs showing changes in capacity depending on charge and discharge cycles in secondary batteries according to Example 1 and Comparative Example 1, respectively.

FIGS. 6A and 6B are images showing volume changes of anodes during repeated charge and discharge of secondary batteries according to Example 1 and Comparative Example 1, respectively.

### BEST MODE

Embodiments of the present disclosure are provided to more fully illustrate the present disclosure to a person having ordinary skill in the art to which the present disclosure pertains, the following embodiments may be modified in various other forms, and the scope of the present disclosure is not limited to the following embodiments.

The anode active material for secondary batteries according to one embodiment includes silicon (Si)-based particles, and the silicon (Si)-based particles include an M-O—Si bond (wherein M is a metal).

The silicon (Si)-based particles used as an anode active material in one embodiment include an M-O—Si bond, thereby controlling the volume change of silicon (Si) that occurs during reaction with lithium ions. In other words, by using silicon (Si) containing the M-O—Si bond as an anode active material, the volume change of silicon generated during repeated charge and discharge can be suppressed and the electrochemical properties of the secondary battery can be improved.

Specifically, the M-O—Si bonds may mean particles with M-O—Si bonds. In other words, the silicon (Si)-based particles may be in the form of an aggregate of a plurality of particles and may include a particle having an M-O—Si bond as one of the plurality of particles.

In the M-O—Si bond, the metal (M) may include B, P, Ge, Ti, Zr or a combination thereof.

The silicon (Si)-based particles according to one embodiment have pure Si—Si bonds, as well as M-O—Si bonds. Specifically, according to the X-ray diffraction (XRD) and the Fourier-transform infrared (FT-IR) spectrum for silicon (Si)-based particles, silicon (Si)-based particles may have pure Si—Si bonds as well as M-O—Si bonds. Here, the Si—Si bonds may mean particles having Si—Si bonds.

More specifically, the silicon (Si)-based particles have transmittance peaks corresponding to the M-O—Si bonds at 800 cm⁻¹ to 900 cm⁻¹ wavenumbers, 650 cm⁻¹ to 750 cm⁻¹ wavenumbers, or a combination thereof in the FT-IR spectrum. The transmittance peaks corresponding to the M-O—Si bonds may be observed at 850 cm⁻¹ to 900 cm⁻¹ wavenumbers, 650 cm⁻¹ to 700 cm⁻¹ wavenumbers, or a combination thereof.

The silicon (Si)-based particles may have an average particle diameter of 0.05 μm to 5 μm, for example, 0.05 μm to 1 μm, or 0.1 μm to 0.8 μm. When the average particle diameter of the silicon (Si)-based particles is within the range, an electrode of a high capacity can be obtained.

The silicon (Si)-based particles may be prepared by low-temperature reduction using waste glass containing silica and metal oxide.

The waste glass may be heat-strengthened glass used for display liquid crystals such as cellular phones. Most of waste glass generated during disposal of displays cannot be recycled and embedded, thus causing environmental pollution. In an embodiment, the waste glass is used as a raw material for anode active materials, thereby recycling waste glass of displays, reducing environmental pollution, and thus providing eco-friendliness.

In addition, when the conventional process of preparing silicon from silica is based on a carbothermal process, a high temperature of 1,700° C. or higher is required. When a metal reducing agent such as magnesium or aluminum is used, it is difficult to control the structure due to exothermic reaction at 2,500° C. or higher. Meanwhile, in an embodiment, the use of waste glass eliminates the necessity of equipment associated with the high-temperature process, thus greatly reducing the cost for raw materials, easily controlling the structure based on low-temperature reduction, and preparing silicon with high purity.

Specifically, in an embodiment, the silicon (Si)-based particles may be prepared by reducing waste glass containing silica and metal oxide at a temperature of 200 to 350° C., for example, at a temperature of 200 to 300° C., or at a temperature of 200 to 280° C.

When the silicon (Si)-based particles are prepared at a low reduction temperature within the range defined above, the structure can be easily controlled, highly pure silicon particles can be obtained, and the prepared silicon particles contain M-O—Si bonds, thus preventing changes in volume of silicon (Si) during charge and discharge,

The metal of the metal oxide is the same as the metal (M) in the M-O—Si bond. For example, the metal oxide may include boron oxide, phosphorous oxide, germanium oxide, titanium oxide, zirconium oxide or a combination thereof.

The preparation of the silicon (Si)-based particles may be performed using a reducing agent. The reducing agent may include Al, AlCl₃, Zn, Mg, Ca or a combination thereof. For example, the reducing agent may be a combination of Al and AlCl₃. In this case, the Al and AlCl₃ may be present at a weight ratio of 1:5 to 1:20, for example, 1:10 to 1:20.

Hereinafter, a secondary battery containing the anode active material will be described.

The secondary battery includes a cathode, an anode and an electrolyte.

The anode using the silicon (Si)-based particles according to an embodiment as the anode active material may have a high capacity. Specifically, the anode may have a capacity of 800 mAh/g to 1,700 mAh/g at 1 C, for example, 800 mAh/g to 1,500 mAh/g at 1C, or 900 mAh/g to 1,200 mAh/g at 1 C.

The anode using the silicon (Si)-based particles according to an embodiment as the anode active material may inhibit a change in volume during charge and discharge. Specifically, the change in volume after 50 charge cycles may be 5 to 40%, for example, 5% to 20%, or 10% to 18%.

The anode includes a current collector and an anode active material layer disposed on the current collector.

The current collector may be a copper foil, nickel foil, stainless steel foil, titanium foil, a nickel foam, a copper foam, a polymer coated with a conductive metal, or a combination thereof, but is not limited thereto.

The anode active material includes the anode active material and may further include a binder and a conductive material.

The binder serves to adhere anode active material particles to each other well and to adhere the anode active material to an anode current collector well. Typical examples of the binder include, but are not limited to, polyvinyl alcohol, carboxymethylcellulose, hydroxypropylcellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resins, nylon and the like.

The conductive material is used to impart conductivity to the electrode and any electrically conductive material may be used in a manufactured battery as long as it does not cause chemical change. Examples thereof include: carbon-based materials such as natural graphite, artificial graphite, carbon black, acetylene black, Ketjen black and carbon fiber; metallic substances such as metal powders or metal fibers containing copper, nickel, aluminum, or silver; conductive polymers such as polyphenylene derivatives; and conductive materials containing a mixture thereof.

The cathode includes a current collector and a cathode active material layer disposed on the current collector.

The current collector may be aluminum, but is not limited thereto.

The cathode active material layer includes a cathode active material. The cathode active material may be a compound capable of reversible intercalation and deintercalation of lithium (lithiated intercalation compound), and may, specifically, be lithium metal oxide. The lithium metal oxide may be an oxide containing lithium and at least one metal selected from cobalt, manganese, nickel, and aluminum.

The cathode active material layer may further contain a binder and a conductive material.

The binder serves to adhere the cathode active material particles to each other well and also to adhere the cathode active material to the cathode current collector well. Typical examples of the binder include, but are not limited to, polyvinyl alcohol, carboxymethylcellulose, hydroxypropylcellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resins, nylon and the like.

The conductive material is used to provide conductivity to the electrode, and any electrically conductive material may be used in a manufactured battery as long as it does not cause chemical change. Examples thereof include: carbon-based materials such as natural graphite, artificial graphite, carbon black, acetylene black, Ketjen black and carbon fiber; metallic substances such as metal powders or metal fibers containing copper, nickel, aluminum, or silver; conductive polymers such as polyphenylene derivatives; and conductive materials containing a mixture thereof.

The anode and the cathode are manufactured by mixing an active material, a conductive material, and a binder in a solvent to prepare an active material composition, and applying the composition to a current collector. This electrode manufacturing method is widely known in the field and detailed description thereof will be omitted herein. The solvent may be N-methylpyrrolidone, but is not limited thereto.

The electrolyte contains a lithium salt and an organic solvent.

The lithium salt is a substance that is dissolved in an organic solvent and serves as a source of lithium ions in a secondary battery, to enable basic operation of the secondary battery and facilitate the movement of lithium ions between the cathode and the anode.

Specific examples of the lithium salt include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (wherein X and y are natural numbers), LiCl, LiI, LiB(C₂O₄)₂ (lithium bis(oxalato) borate; LiBOB) or a combination thereof.

The concentration of the lithium salt may be within a range from about 0.1M to about 2.0M. When the concentration of lithium salt is within the range, the gel electrolyte composition has appropriate conductivity and viscosity, thus exhibiting excellent electrolyte performance, and effectively moving lithium ions.

The organic solvent serves as a medium through which ions involved in the electrochemical reaction of a secondary battery move. The organic solvent is a non-aqueous organic solvent and may be selected from carbonate-based, ester-based, ether-based, ketone-based, alcohol-based, and aprotic solvents.

Examples of the carbonate-based solvent include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and the like.

In particular, when a mixture of a chain carbonate compound and a cyclic carbonate compound is used, the dielectric constant may be increased and a solvent with low viscosity may be prepared. In this case, the cyclic carbonate compound and the chain carbonate compound may be mixed and used in a volume ratio of about 1:1 to 1:9.

In addition, the ester-based solvents include, for example, methyl acetate, ethyl acetate, n-propyl acetate, dimethyl acetate, methyl propionate, ethyl propionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and the ketone-based solvent may be cyclohexanone or the like. In addition, the alcohol-based solvent may be ethyl alcohol, isopropyl alcohol, or the like.

The organic solvent may be used alone or in a mixture of two or more solvents. When two or more solvents are mixed, the mixing ratio may be appropriately adjusted depending on the desired battery performance.

Depending on the type of secondary batteries, a separator may be present between the anode and the cathode. Such a separator may be polyethylene, polypropylene, polyvinylidene fluoride, or a multilayer film of two or more layers thereof, especially, a mixed multilayer film such as a polyethylene/polypropylene two-layer separator, a polyethylene/polypropylene/polyethylene three-layer separator, or a polypropylene/polyethylene/polypropylene three-layer separator.

### Best Mode

Hereinafter, specific examples of the present disclosure will be described. However, the examples described below are only provided to exemplify or illustrate the present disclosure in detail and should not be construed as limiting the scope of the present disclosure. In addition, other details that may be sufficiently conceived by those skilled in the art will be not described.

### Manufacturing of Silicon-Based Particles

### Example 1

Silicon (Si)-based particles were manufactured by low-temperature reduction using, as waste glass produced upon disposal of cellular phones, borosilicate glass (neutral borosilicate glass 5.1, USP and EP Type 1 glass) (containing 85% of SiO₂, 13% of B₂O₃ and 2% of Na) and reducing agents Al and AlCl₃. Specifically, borosilicate glass, Al and AlCl₃ were mixed at a weight ratio of 1:0.8:8, and the resulting mixture was injected into a stainless-steel reactor (Unilok Corporation), and then reacted at 250° C. in an argon atmosphere for 15 hours to produce silicon-based particles. Then impurities were removed through chemical etching in HCl solution.

### Comparative Example 1

Pure silica (SiO₂ 99.5%, 400 mesh, 2 micron APS powder, S.A. surface area 2 m²/g), Al and AlCl₃ were mixed at a weight ratio of 1:0.8:8, and the resulting mixture was placed in a stainless steel reactor (Unilok Corporation), and then reacted at 250° C. in an argon atmosphere for 15 hours to prepare silicon-based particles. Then, impurities were removed through chemical etching in HCl solution.

### Manufacture of Anodes for Secondary Batteries

Each of silicon-based particles prepared in Example 1 and Comparative Example 1 as an anode active material, carbon black as a conductive material, and polyacrylic acid (PAA) as a binder were added to water as a solvent at a weight ratio of 60:20:20, respectively, to prepare a cathode mixture slurry (solid content: 50% by weight). The anode mixture slurry was applied to a 20 μm thick copper (Cu) thin film, which is an anode current collector, and dried to prepare each anode.

### Test 1: Scanning Electron Microscopy (SEM) of Anode Active Material

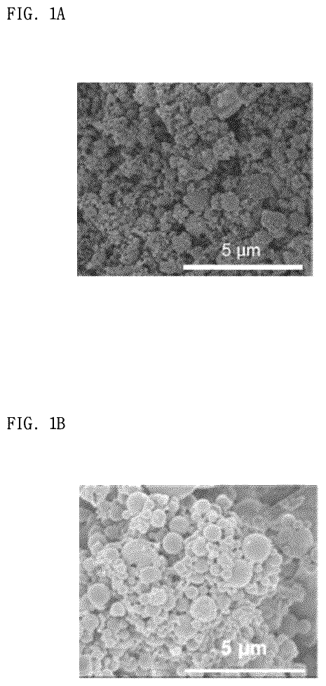

Scanning electron microscopy (SEM) was performed on the surfaces of the silicon-based particles prepared in Example 1 and Comparative Example 1 as anode active materials, and the results are shown in FIGS. 1A and 1B.

FIGS. 1A and 1B are scanning electron microscope (SEM) images of anode active materials for secondary batteries according to Example 1 and Comparative Example 1, respectively.

As can be seen from FIGS. 1A and 1B, in Example 1, silicon-based particles having a size of 1 micrometer or less were manufactured. In addition, in Comparative Example 1, silicon-based particles with a size of 1 micrometer or less were manufactured and the silicon-based particles had uniform surfaces.

### Test 2: X-Ray Diffraction (XRD) of Anode Active Material

X-ray diffraction (XRD) analysis was performed on

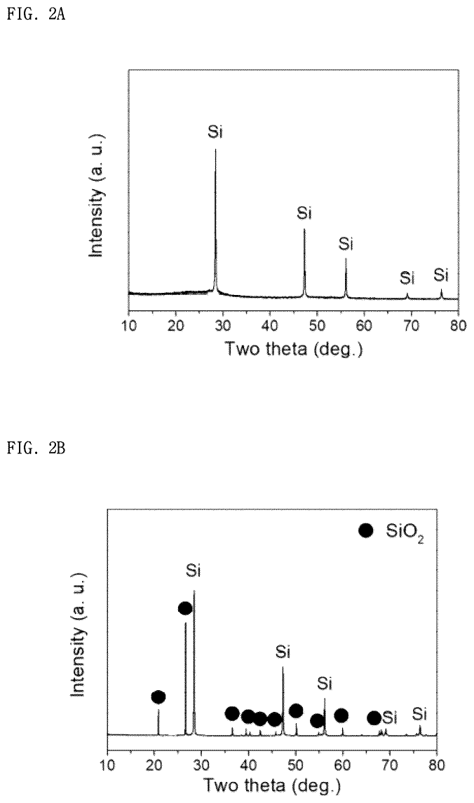

the silicon-based particles prepared in Example 1 and Comparative Example 1 as anode active materials, and the results are shown in FIGS. 2A and 2B.

FIGS. 2A and 2B are X-ray diffraction analysis (XRD) graphs of anode active materials for secondary batteries according to Example 1 and Comparative Example 1, respectively.

As can be seen from FIGS. 2A and 2B, the silicon-based particles prepared in Example 1 were pure silicon (Si)-based particles synthesized within the silicon-based particles, whereas in the silicon-based particles prepared in Comparative Example 1, unreacted silica (SiO₂) particles still exist even after etching with HCl. Accordingly, it can be seen that the silicon-based particles according to one embodiment are particles having high silicon (Si) purity while containing M-O—Si bonds.

### Test 3: Fourier Transform Infrared (FT-IR) Spectrometry of Cathode Active Material

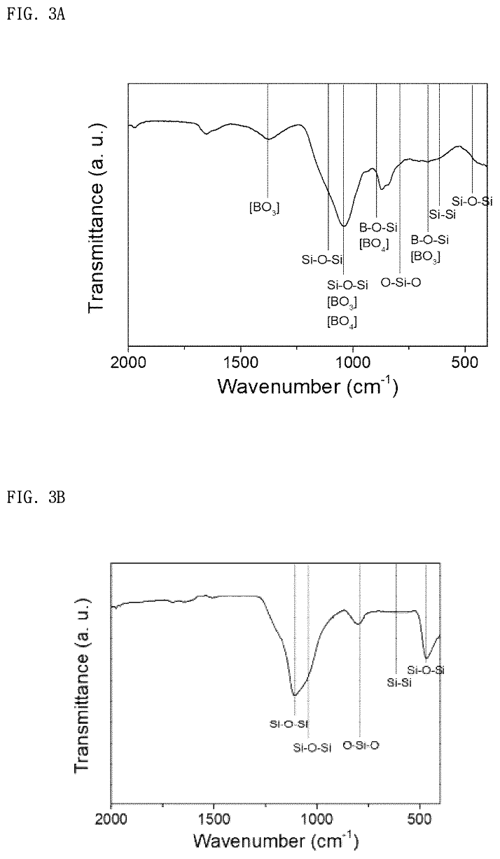

Fourier transform-infrared (FT-IR) spectrometry was performed on the silicon-based particles prepared in Example 1 and Comparative Example 1 as anode active materials and the results are shown in FIGS. 3A and 3B.

FIGS. 3A and 3B are graphs showing the Fourier-transform infrared (FT-IR) spectra of anode active materials for secondary batteries according to Example 1 and Comparative Example 1, respectively.

As can be seen from FIGS. 3A and 3B, the silicon-based particles prepared in Example 1 include pure Si—Si bonds and thus further have B—O—Si bonds and Si—O—Si bonds. On the other hand, it can be seen that, in silicon-based particles prepared in Comparative Example 1, only Si—O—Si bonds and Si—Si bonds are present due to silica residues. Accordingly, it can be seen that the silicon-based particles according to one embodiment are particles containing M-O—Si bonds.

### Test 4: Measurement of Electrochemical Properties of Secondary Batteries

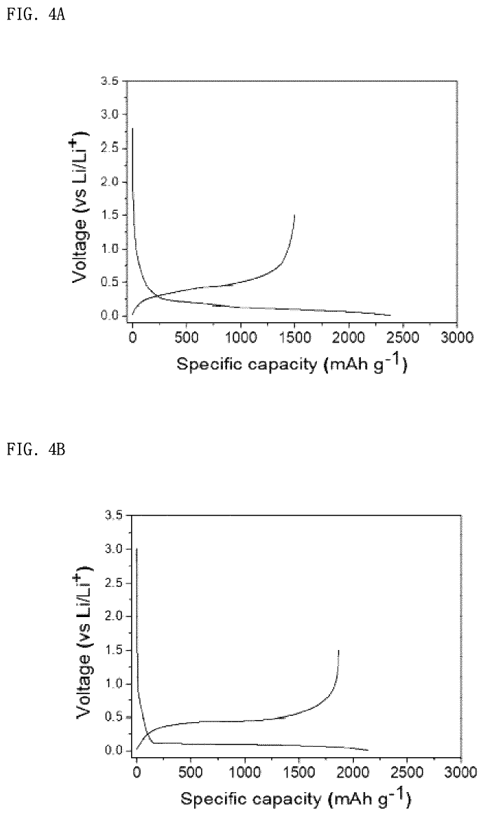

Each half-cell was manufactured using a Li counter electrode and each of the anodes prepared according to Example 1 and Comparative Example 1. The initial charge/discharge cycle was performed at 0.05 C for the half cell, and the resulting discharge capacity is shown in FIGS. 4A and 4B.

FIGS. 4A and 4B are graphs showing changes in voltage and discharge capacity depending on the initial cycle of charge and discharge in the secondary batteries according to Example 1 and Comparative Example 1, respectively.

As can be seen from FIGS. 4A and 4B, the discharge capacity of Example 1 was about 1,500 mAh/g, whereas the discharge capacity of Comparative Example 1 was about 1,800 mAh/g.

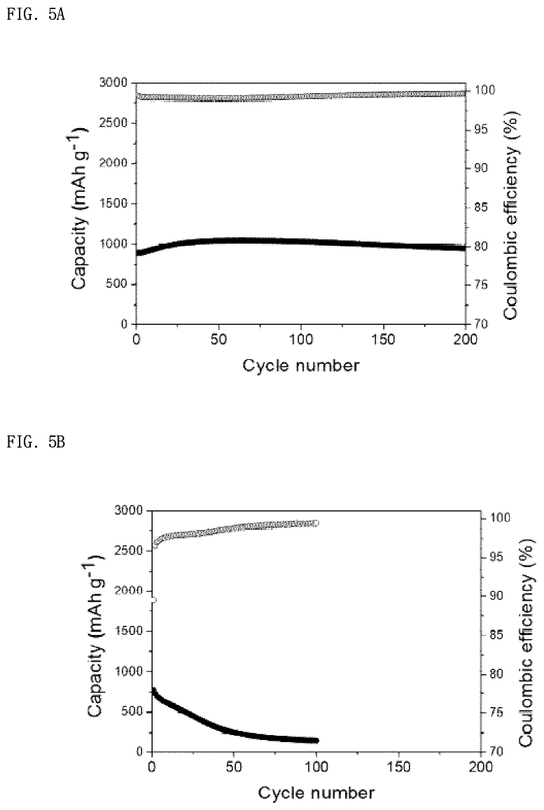

After the initial charge/discharge cycle, a long-term lifespan test was conducted in a fast charge/discharge experiment at 1 C. The results are shown in FIGS. 5A and 5B.

FIGS. 5A and 5B are graphs showing changes in capacity depending on charge and discharge cycles in secondary batteries according to Example 1 and Comparative Example 1, respectively.

As can be seen from FIGS. 5A and 5B, in Example 1, a specific capacity of about 1,000 mAh/g was maintained for up to 200 cycles, while in Comparative Example 1, almost no capacity was obtained after 100 cycles. In other words, it can be seen that the capacity of Comparative Example 1 was reduced because the battery could not withstand the volume change during repeated charging and discharging.

This means that, when silicon-based particles containing M-O—Si bonds are used as the anode active material according to one embodiment, the change in the volume of the anode is suppressed and thus the electrochemical properties are improved.

### Test 5: Measurement of Volume Change of Anode

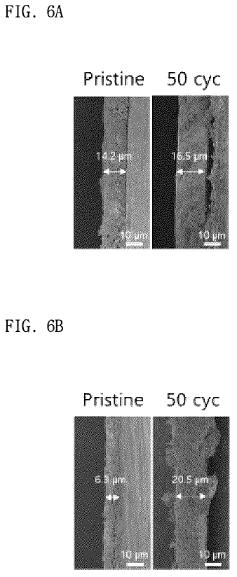

Each half-cell was manufactured using a Li counter electrode and each of the anodes prepared according to Example 1 and Comparative Example 1. After an initial charge/discharge cycle was performed at 0.05 C for the half cell, 50 cycles of charge/discharge were repeated at a rate of 0.5 C, the volume change of the anode was then measured, and the results are shown in FIGS. 6A and 6B.

FIGS. 6A and 6B are images showing volume changes of anodes during repeated charge and discharge of secondary batteries according to Example 1 and Comparative Example 1, respectively.

As can be seen from FIGS. 6A and 6B, in Example 1, the volume was increased by about 16%, while in Comparative Example 1, the volume was increased by about 225%. That is, it can be seen that, in Comparative Example 1, the volume change was not controlled during repeated charging and discharging.

This means that, when the silicon-based particles containing M-O—Si bonds are used as the anode active material according to one embodiment, the change in the volume of the anode is suppressed.

Although preferred embodiments of the present disclosure have been disclosed for illustrative purposes, those skilled in the art will appreciate that various modifications, additions, and substitutions are possible without departing from the scope and spirit of the disclosure as disclosed in the accompanying claims with reference to the accompanying drawings.

1. An anode active material for a secondary battery comprising silicon (Si)-based particles,
wherein the silicon (Si)-based particles comprise a M-O—Si bond (wherein M is a metal).

2. The anode active material as claimed in claim 1, wherein the metal (M) comprises B, P, Ge, Ti, Zr, or a combination thereof.

3. The anode active material as claimed in claim 1, wherein the silicon (Si)-based particles further comprise an Si—Si bond.

4. The anode active material as claimed in claim 1, wherein the silicon (Si)-based particles are manufactured by reducing waste glass containing silica and metal oxide at a temperature of 200° C. to 350° C.

5. The anode active material as claimed in claim 1, wherein the silicon (Si)-based particles have transmittance peaks corresponding to M-O—Si bonds at 800 cm⁻¹ to 900 cm⁻¹ wavenumbers, 650 cm⁻¹ to 750 cm⁻¹ wavenumbers, or a combination thereof in a Fourier transform-infrared (FT-IR) spectrum.

6. The anode active material as claimed in claim 1, wherein the silicon (Si)-based particles have an average particle diameter of 0.05 μm to 5 μm.

7. A method of manufacturing an anode active material for a secondary battery, the method comprising reducing waste glass containing silica and metal oxide at a temperature of 200° C. to 350° C. to produce silicon (Si)-based particles,
wherein the produced silicon (Si)-based particles comprise a M-O—Si bond (wherein M is a metal).

8. The method as claimed in claim 7, wherein the waste glass is heat-strengthened glass produced by display disposal.

9. The method as claimed in claim 7, wherein the metal of the metal oxide and the metal (M) comprise B, P, Ge, Ti, Zr, or a combination thereof.

10. The method as claimed in claim 7, wherein the reduction is performed by adding a reducing agent containing Al, AlCl₃, Zn, Mg, Ca, or a combination thereof.

11. A secondary battery comprising:
an anode comprising the anode active material as claimed in claim 1;
a cathode; and
an electrolyte.

12. The secondary battery as claimed in claim 11, wherein the anode has a capacity of 800 mAh/g to 1,700 mAh/g at 1 C.

13. The secondary battery as claimed in claim 11, wherein the anode has a volume change of 5% to 40% after 50 cycles of charge and discharge at 0.5 C.
